(19) United States
(12) Patent Application Publication
(10) Pub. No.: US 2020/0005301 A1
(43) Pub. Date: Jan. 2, 2020

(54) METHOD AND SYSTEM FOR SPEND CONTROLS FOR A VIRTUAL CARD NUMBER WITH MULTIPLE FUNDING SOURCES

(71) Applicant: MASTERCARD INTERNATIONAL INCORPORATED, Purchase, NY (US)

(72) Inventors: Saravana Perumal Shanmugam, Fremont, CA (US); Nicolas Buc, Larchmont, NY (US); Robert Collins, Blackrock (IE)

(73) Assignee: MASTERCARD INTERNATIONAL INCORPORATED, Purchase, NY (US)

(21) Appl. No.: 16/024,995

(22) Filed: Jul. 2, 2018

(51) Int. Cl. G06Q 20/40; G06Q 20/34

(52) U.S. Cl. CPC G06Q 20/405; G06Q 20/351; G06Q 20/3572

(57) ABSTRACT

A method for processing a controlled payment number transaction with multiple funding sources includes: receiving an authorization request for a payment transaction including at least a transaction amount and a controlled payment number; identifying a mapping profile including at least the controlled payment number, an overflow transaction account number, and at least one spend profile, the at least one spend profile including at least a mapped transaction account number and one or more spend controls including at least a maximum payment amount; processing a first payment transaction for payment from the mapped transaction account number for the maximum payment amount; processing a second payment transaction for payment from the overflow transaction account number for an amount based on a difference between the transaction amount and the maximum payment amount; and transmitting an authorization response for the payment transaction including at least the controlled payment number.

### FIELD

The present disclosure relates to the processing of payment transactions using controlled payment numbers where the transaction is funded via multiple, separate funding sources while using a single controlled payment number, enabling limited-use funds, such as for vouchers or gift cards, supplied by a third party to be used in conjunction with a cardholder's transaction account while using only a single payment instrument.

### BACKGROUND

Controlled payment numbers provide a valuable service to cardholders, financial institutions, and merchants alike. Controlled payment numbers, as defined in more detail below, are limited-use account numbers that are mapped to a standard transaction account that are subject to one or more controls on usage for funding an electronic payment transaction. Controlled payment numbers can be used to help a cardholder limit their spending or adhere to a budget, can be given to a friend, family member, or employee for a one-time purchase or limited use, and can be used to help prevent fraud by enabling a cardholder to transact without their real, primary account number.

Such benefits may also be realized in a gifting context, such as with gift cards. A merchant can have a controlled payment number generated for their own transaction account, which can then be provisioned to a consumer as a gift card. The gift card controlled payment number could be limited in use to only that merchant and for a specified amount. Any individual or other entity could similarly create their own gift card that is drawn from their own transaction account, made for any possible amount and enabled for use at a list of merchant specially curated by themselves, providing for nearly limitless customization.

However, as with standard gift cards, transaction amount limits are often insufficient for covering a full transaction. As a result, the consumer that is redeeming the gift card must first use the gift card and then present an alternative payment method. While many point of sale devices are configured to allow such a payment process with traditional gift cards, many are incapable of doing so for multiple controlled payment numbers. Thus, there may be instances where issuing a gift or voucher as a controlled payment number may be undesirable if there is a possibility it may not cover the amount of a full transaction.

In addition, there are instances where an entity may be interested in providing a consumer with multiple gifts or vouchers. For example, an airline that has a flight delay or cancellation may want to give a passenger several vouchers, such as two separate vouchers for meals and a voucher for lodging. Traditionally, the airline would have to produce three physical vouchers to give to the passenger, that he or she would have to keep track of and use correctly. In addition, the merchants with whom the vouchers may be redeemed must have point of sale systems capable of handling the vouchers. In more recent times, the airline may be interested in using controlled payment numbers in place of the vouchers, where the airline may generate three controlled payment numbers (e.g., two limited to use at restaurants, one to use at hotels, and for the applicable amounts) that are given to the passenger. However, as discussed above, many point of sale systems may be unable to accommodate use of the controlled payment number if the transaction amount exceeds the limit set for that voucher. The result is that the passenger may be restricted to transacting entirely within the transaction amount limit that is set, and must also keep track of which number was issued for what purpose. In cases where large number of vouchers may be issued (e.g., to a head of a tour group where the leader may be provided with multiple vouchers for each of several dozen tourists), this may become exceedingly difficult and frustrating for the consumer.

Thus, there is a need for a technological solution to enable a single controlled payment number to be issued that can be utilized for multiple vouchers or gifts, while at the same time be processed in a payment transaction for an amount beyond any control amount, such that it may be used at standard points of sale without requiring special modification by merchants.

### SUMMARY

The present disclosure provides a description of systems and methods for processing controlled payment number (CPN) transactions with multiple funding sources. When a gift or voucher is to be given to a consumer, a CPN is issued on the transaction account of the consumer with multiple sets of controls mapped thereto. Each of the sets of controls is also mapped to a transaction account, such that any transaction that adheres to those controls is funded by its respective, mapped transaction account. Any overflow in a transaction is paid out by the consumer's transaction account on which the CPN is issued. The processing of these multiple parts of the transaction is performed as separate transactions on the back end, enabling a merchant point of sale to handle the transaction using standard processes. The result is that a consumer may be provided with several vouchers via a single CPN issued thereto, which can be used in legacy point of sale systems, and still subject to any limits or controls desired by the vendor providing the vouchers. Thus, providing a technical solution to the various problems faced in gift card and voucher redemption, as well as processing of transactions using CPNs.

A method for processing a controlled payment number transaction with multiple funding sources includes: receiving, by a receiver of a processing server, an authorization request for a payment transaction, wherein the authorization request is formatted according to one or more standards and includes at least a plurality of data elements including at least a first data element configured to store a transaction amount and a second data element configured to store a controlled payment number; identifying, by the processing server, a mapping profile, wherein the mapping profile includes at least the controlled payment number, an overflow transaction account number, and at least one spend profile, the at least one spend profile including at least a mapped transaction account number and one or more spend controls including at least a maximum payment amount; processing, by the processing server, a first electronic payment transaction for payment from a transaction account corresponding to the mapped transaction account number for the maximum payment amount; processing, by the processing server, a second electronic payment transaction for payment from a transaction account corresponding to the overflow transaction account number for an amount based on a difference between the transaction amount and the maximum payment amount; and electronically transmitting, by a transmitter of the processing server, an authorization response for the payment transaction, wherein the authorization response is formatted according to the one or more standards and includes at least a plurality of data elements including at least a first data element configured to store the controlled payment number.

A system for processing a controlled payment number transaction with multiple funding sources includes: a receiver of a processing server configured to receive an authorization request for a payment transaction, wherein the authorization request is formatted according to one or more standards and includes at least a plurality of data elements including at least a first data element configured to store a transaction amount and a second data element configured to store a controlled payment number; the processing server configured to identify a mapping profile, wherein the mapping profile includes at least the controlled payment number, an overflow transaction account number, and at least one spend profile, the at least one spend profile including at least a mapped transaction account number and one or more spend controls including at least a maximum payment amount, process a first electronic payment transaction for payment from a transaction account corresponding to the mapped transaction account number for the maximum payment amount, process a second electronic payment transaction for payment from a transaction account corresponding to the overflow transaction account number for an amount based on a difference between the transaction amount and the maximum payment amount; and a transmitter of the processing server configured to electronically transmit an authorization response for the payment transaction, wherein the authorization response is formatted according to the one or more standards and includes at least a plurality of data elements including at least a first data element configured to store the controlled payment number.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for processing controlled payment number transactions with multiple funding sources in accordance with exemplary embodiments.

FIG. 2 is a block diagram illustrating the processing server of the system of FIG. 1 for processing controlled payment number transactions with multiple funding sources in accordance with exemplary embodiments.

FIG. 3 is a flow diagram illustrating a process for provisioning a controlled payment number that utilizes multiple funding sources and use thereof in the system of FIG. 1 in accordance with exemplary embodiments.

FIG. 4 is a flow chart illustrating an exemplary method for processing a controlled payment number transaction in accordance with exemplary embodiments.

FIG. 5 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes for thousands, millions, and even billions of transactions during a given period. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Payment Rails—Infrastructure associated with a payment network used in the processing of payment transactions and the communication of transaction messages and other similar data between the payment network and other entities interconnected with the payment network that handles thousands, millions, and even billions of transactions during a given period. The payment rails may be comprised of the hardware used to establish the payment network and the interconnections between the payment network and other associated entities, such as financial institutions, gateway processors, etc. In some instances, payment rails may also be affected by software, such as via special programming of the communication hardware and devices that comprise the payment rails. For example, the payment rails may include specifically configured computing devices that are specially configured for the routing of transaction messages, which may be specially formatted data messages that are electronically transmitted via the payment rails.

Transaction Account—A financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc.

Issuer—An entity that establishes (e.g., opens) a letter or line of credit in favor of a beneficiary, and honors drafts drawn by the beneficiary against the amount specified in the letter or line of credit. In many instances, the issuer may be a bank or other financial institution authorized to open lines of credit. In some instances, any entity that may extend a line of credit to a beneficiary may be considered an issuer. The line of credit opened by the issuer may be represented in the form of a payment account, and may be drawn on by the beneficiary via the use of a payment card. An issuer may also offer additional types of payment accounts to consumers as will be apparent to persons having skill in the relevant art, such as debit accounts, prepaid accounts, electronic wallet accounts, savings accounts, checking accounts, etc., and may provide consumers with physical or non-physical means for accessing and/or utilizing such an account, such as debit cards, prepaid cards, automated teller machine cards, electronic wallets, checks, etc.

Merchant—An entity that provides products (e.g., goods and/or services) for purchase by another entity, such as a consumer or another merchant. A merchant may be a consumer, a retailer, a wholesaler, a manufacturer, or any other type of entity that may provide products for purchase as will be apparent to persons having skill in the relevant art. In some instances, a merchant may have special knowledge in the goods and/or services provided for purchase. In other instances, a merchant may not have or require any special knowledge in offered products. In some embodiments, an entity involved in a single transaction may be considered a merchant. In some instances, as used herein, the term “merchant” may refer to an apparatus or device of a merchant entity.

Payment Transaction—A transaction between two entities in which money or other financial benefit is exchanged from one entity to the other. The payment transaction may be a transfer of funds, for the purchase of goods or services, for the repayment of debt, or for any other exchange of financial benefit as will be apparent to persons having skill in the relevant art. In some instances, payment transaction may refer to transactions funded via a payment card and/or payment account, such as credit card transactions. Such payment transactions may be processed via an issuer, payment network, and acquirer. The process for processing such a payment transaction may include at least one of authorization, batching, clearing, settlement, and funding. Authorization may include the furnishing of payment details by the consumer to a merchant, the submitting of transaction details (e.g., including the payment details) from the merchant to their acquirer, and the verification of payment details with the issuer of the consumer's payment account used to fund the transaction. Batching may refer to the storing of an authorized transaction in a batch with other authorized transactions for distribution to an acquirer. Clearing may include the sending of batched transactions from the acquirer to a payment network for processing. Settlement may include the debiting of the issuer by the payment network for transactions involving beneficiaries of the issuer. In some instances, the issuer may pay the acquirer via the payment network. In other instances, the issuer may pay the acquirer directly. Funding may include payment to the merchant from the acquirer for the payment transactions that have been cleared and settled. It will be apparent to persons having skill in the relevant art that the order and/or categorization of the steps discussed above performed as part of payment transaction processing.

Controlled Payment Number—Controlled payment numbers may be payment numbers associated with a payment account that are subject to one or more rules. In many cases, these rules may be set by a cardholder, such as spending limits, limits on days and/or times of a transaction, limits on merchants or industries, transaction spending or frequency limits, etc. Controlled payment numbers may offer an account holder an opportunity to give payment cards tied to the account to others for use, but subject to rules set by the cardholder, such as an employer distributing cards to employees, or a parent distributing cards to children. Additional detail regarding controlled payment numbers may be found in U.S. Pat. No. 6,636,833, issued Oct. 21, 2003; U.S. Pat. No. 7,136,835, issued Nov. 14, 2006; U.S. Pat. No. 7,571,142, issued Aug. 4, 2009; U.S. Pat. No. 7,567,934, issued Jul. 28, 2009; U.S. Pat. No. 7,593,896, issued Sep. 22, 2009; U.S. Pat. No. 7,359,880, issued Apr. 15, 2008; U.S. Pat. No. 7,895,122, issued Feb. 22, 2011; U.S. Pat. No. 8,229,854, issued Jul. 27, 2012; U.S. Pat. No. 8,321,315, issued Nov. 27, 2012; U.S. Pat. No. 8,510,218, issued Aug. 13, 2013; U.S. Pat. No. 8,639,623, issued Dec. 27, 2012; U.S. Pat. No. 8,756,150, issued Jun. 17, 2014; and U.S. Pat. No. 8,527,416, issued Sep. 3, 2013, each of which are herein incorporated by reference in their entirety.

### System for Processing Controlled Payment Number Transactions

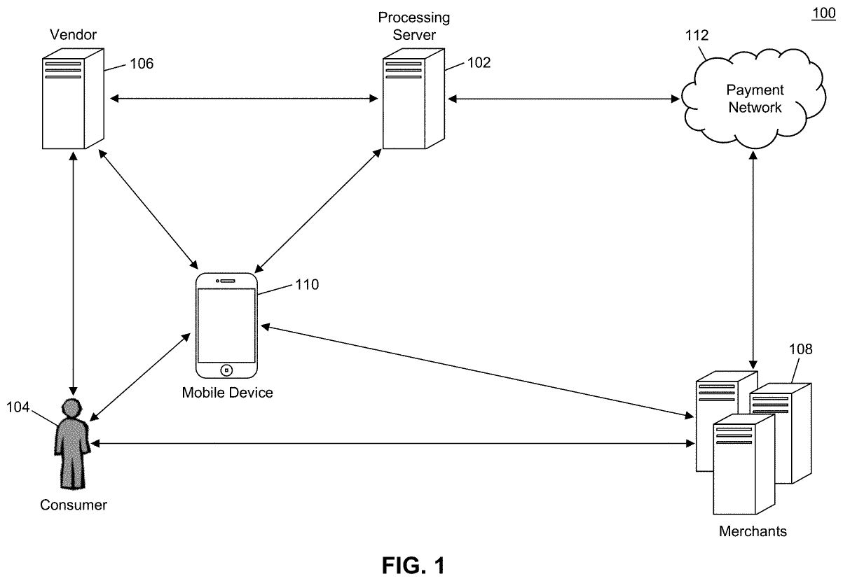

FIG. 1 illustrates a system 100 for the processing of electronic payment transactions utilizing controlled payment numbers that are funded via multiple funding sources and are subject to multiple sets of spend controls.

The system 100 may include a processing server 102. The processing server 102, discussed in more detail below, may be configured to perform processing functions for electronic payment transactions that utilize a controlled payment number (CPN) that is subject to multiple sets of spend controls and where the transaction is funded through multiple, separate funding sources. In the system 100, a consumer 104 may engage with a vendor 106, where the vendor 106 may be interested in providing the consumer 104 with one or more vouchers, gift cards, or similar type of gift. For instance, the vendor 106 may be an airline interested in giving the consumer 104, a passenger of the airline, several vouchers due to a delay or in response to the consumer 104 taking a bump. The vendor 106 may be interested in giving the consumer 104 multiple vouchers, each redeemable at one or more merchants 108. In some embodiments, each of the vouchers may have a different set of merchants 108 with which it may be redeemed. For instance, in the above example, the airline may want to give the consumer 104 a first voucher redeemable at a restaurant, a second voucher redeemable at a hotel, and a third voucher redeemable at the airline for a future ticket purchase.

In the system 100, the vouchers may be implemented via a single CPN issued to the consumer 104 for use in future payment transactions, where the vouchers may be redeemed based on usage of the CPN at various merchants 108 as specified in spend controls provided by the vendor 106. The vendor 106 may contact the processing server 102 using any suitable communication network and method (e.g., a web page, application program, application programming interface, short messaging service, e-mail, telephone, etc.) and provide the processing server 102 with spend controls for each of the vouchers being issued, as well as account information for a transaction account to be used to fund each of the vouchers. The account information may include at least a transaction account number and any other payment credentials necessary for use in processing a payment transaction funded via the related transaction account. In some cases, the vendor 106 may provide account information for a single transaction account used to fund all of the vouchers. In other cases, the vendor 106 may supply multiple sets of account information and may specify which accounts should be used to fund which vouchers.

The spend controls may be provided by the vendor 106 as limits on the applicability of the corresponding voucher in payment transactions to be funded through a subsequent CPN. Spend controls may be limits placed on any aspect of a transaction that may be identified during processing of an attempted electronic payment transaction. Controls may be placed on, for instance, transaction amount, transaction time, transaction date, currency type, transaction type, geographic location, merchant identifier, merchant category code, product identifier, product category, number of transaction, transaction frequency, aggregate transaction amount, etc. For instance, in the above example, a voucher issued for redemption at restaurants may have spend controls for the total transaction amount, merchant category code (e.g., only restaurants) or a specific list of merchants (e.g., participating restaurants in the airport), transaction date (e.g., day of the delay), and geographic area (e.g., within the airport). A voucher issued for redemption at the airlines, in the above example, may have different spend controls, such as a higher transaction amount, wider range of accepted transaction dates, and no limit on geographic area.

The processing server 102 may receive the spend controls and account information from the vendor 106 and be configured to associate a spend profile for each of the vouchers (e.g., set of spend controls and corresponding account information) with a CPN. The CPN may be generated or otherwise identified (e.g., selected from a list of available CPNs, requested from a third party service, etc.) by the processing server 102. The CPN may be mapped directly to a transaction account issued to the consumer 104 by a financial institution, such as an issuing bank, or other entity configured to issue transaction accounts for use in funding electronic payment transactions. The processing server 102 may receive account information for the consumer's transaction account from the consumer 104, the vendor 106, the transaction account's issuer, or other suitable source.

For instance, in one example, the vendor 106 may provide the processing server 102 with the spend controls and account information for the vouchers, as well as contact information for the consumer 104. The processing server 102 may use the contact information to contact the consumer 104 to request the account information therefrom, such as via a mobile device 110 associated with the consumer 104. For example, the vendor 106 may provide the processing server 102 with a device identifier (e.g., media access control address, internet protocol address, telephone number, registration number, serial number, etc.) associated with the mobile device 110, where the processing server 102 may electronically transmit a message to the mobile device 110 requesting account information from the consumer 104. The consumer 104 may then respond with the account information (e.g., transaction account number and any other payment credentials, which may also be accompanied by authentication information used to authenticate the consumer 104 as an authorized user of the associated transaction account).

In another example, the vendor 106 may obtain the account information directly from the consumer 104. For instance, the vendor 106 may electronically transmit a short messaging service message to the consumer's mobile device 110 inquiring if the consumer 104 is interested in the vouchers. The consumer 104 may respond in the affirmative and may include their account information in the response, or may provide the account information to the vendor 106 separately. For instance, in the above example, the consumer 104 may approach an employee of the airline and present a payment instrument for the transaction account through which the account information may be obtained. The vendor 106 may then include the consumer's account information in the transmission to the processing server 102 when registering the vouchers.

Once the processing server 102 has obtained the account information for the consumer's transaction account, the CPN may be identified or otherwise issued where the consumer's transaction account may be used for any payment transaction conducted using the CPN to which no voucher applies, or for any transaction amount that goes beyond an applicable voucher. The processing server 102 may be configured to provision the CPN directly to the consumer's mobile device 110, or to the vendor 106 or a third party, which may provide the CPN to the consumer's mobile device 110. The mobile device 110 may be any type of computing device suitable for performing the functions discussed herein, such as a cellular phone, smart phone, smart watch, wearable computing device, implantable computing device, laptop computer, notebook computer, tablet computer, etc. In some embodiments, the CPN may be issued to the consumer 104 as a physical payment instrument. For example, a payment card that is encoded or otherwise configured to convey the CPN may be issued to the consumer 104 and physically delivered thereto.

The processing server 102 may be configured to map the CPN to the consumer's transaction account, referred to herein as the overflow transaction account, as well as to each of the spend profiles, each spend profile corresponding to a voucher as registered by the vendor 108. In the above example, the CPN may be mapped to the passenger's transaction account for all overflow as well as to three spend profiles, each of which are subject to spend controls (e.g., for the restaurant, hotel, and airline vouchers) and are mapped to a separate transaction account supplied by the airline. In some embodiments, the CPN itself may be subject to additional spend controls. For instance, the CPN may have an expiration date, geographic area, or other controls associated therewith such that the consumer 104 may not continue to utilize the CPN beyond use of the vouchers. For example, the CPN may have an expiration date that matches the further expiration date of the vouchers, may have a geographic area limited to the airport in the above example or the city in which it is located, and may have an overall transaction amount limit.

Once the consumer 104 has received the CPN, the consumer 104 may use the CPN to fund electronic payments with merchants 108. The consumer 104 may visit a merchant 108 and present the CPN for payment. The merchant 108 may collect the CPN, and any additional payment credentials (e.g., name, expiration date, security code, payment cryptograms, application transaction counter, etc.), and submit the transaction for processing using traditional methods and systems. As part of the processing, transaction data may be submitted to a payment network 112 for processing thereof. The payment network 112 may receive an authorization request for the payment transaction, either directly from the merchant 108 or through one or more intermediate entities (e.g., acquiring institutions, gateway processors, etc.), via payment rails associated with the payment network 112. The authorization request may be a transaction message that is specially formatted according to one or more standards governing the interchange of financial transaction messages, such as the International Organization of Standardization's ISO 8583 or ISO 20022 standards. The authorization request may be a request for authorization of an electronic payment transaction that is to be funded using the CPN as included therein.

The authorization request may include at least a plurality of data elements. Each data element may be configured to store transaction data for the related payment transaction, where the number of data elements and data to be stored therein may be indicated in one or more bitmaps included in the transaction message. The authorization request may include, for instance, a first data element configured to store a transaction amount and a second data element configured to store the CPN. Additional transaction data that may be stored in the authorization request may include, for instance, transaction time, transaction date, currency type, point of sale type, geographic location, merchant identifier, merchant category code, product category, product data, transaction type, reward data, offer data, loyalty data, etc.

The payment network 112 may receive the authorization request and may perform any additional functions, such as value added services, related to the receipt thereof as may be necessary for the processing of an electronic payment transaction. For instance, the payment network 112 may be configured to perform fraud scoring or other services. As part of the processing of the electronic payment transaction, the payment network 112 may be configured to route the authorization request based on the account number used to fund the transaction. In the system 100, the payment network 112 may identify the CPN and may thereby route the transaction to the processing server 102. In some cases, the CPN may include an identifier associated with the processing server 102, such as a bank identification number or issuer identification number, that may comprise a portion of the CPN and be used to route any transaction messages that include the CPN to the processing server 102. In some embodiments, the processing server 102 may be a part of the payment network 112 and may receive the authorization request through internal communications of the payment network 102. In other embodiments, the processing server 102 may be external to the payment network 112 and receive the authorization request via payment rails associated therewith.

The processing server 102 may receive the authorization request and may identify the mapping profile that is associated with the CPN, which includes the overflow transaction account information as well as each of the spend profiles applicable thereto. The processing server 102 may determine if any of the spend profiles (e.g., vouchers) are applicable to the proposed payment transaction. The determination may be based on the spend controls included in the spend profile and the transaction data included in the authorization request. For instance, in the above example, the processing server 102 may identify if the merchant category code and/or merchant identifier in the authorization request is in the eligible list of merchants for redemption of the meal, hotel, or airline vouchers, as well as determining if the geographic location of the transaction is within the acceptable geographic area and if the transaction date is within any provided expiration dates. If no vouchers are applicable, then the processing server 102 may process the payment transaction as a standard payment transaction using the overflow transaction account. In such an instance, the CPN may be replaced by the overflow transaction account information in the authorization request, and the authorization request forwarded to the overflow transaction account's issuer for authorization thereof. The processing server 102 may replace the overflow transaction account information with the CPN in an authorization response returned by the issuer before forwarding the authorization response to the payment network 112 for finalizing of the payment transaction.

If a voucher is determined by the processing server 102 to be applicable, then the processing server 102 may process a series of transaction accounts for redemption of the applicable voucher. The processing server 102 may process a first payment transaction that is to be funded by the transaction account associated with the voucher (e.g., using the account information included in the respective spend profile as supplied by the vendor 106) and for a transaction amount that does not exceed the spend control associated therewith. In cases where the transaction amount for the initial payment transaction is less than the amount set for the voucher, then only a single payment transaction may be processed by the processing server 102 using the voucher's account information for that transaction amount. In some such cases, the processing server 102 may use the original authorization request with the voucher's account information used in place of the CPN. In cases where the transaction amount for the initial payment transaction is greater than the voucher's acceptable amount, the processing server 102 may process the first payment transaction for the voucher's acceptable amount and may also process a second payment transaction for an overflow amount (e.g., the different between the initial transaction's amount and the voucher's amount). The second payment transaction may be funded by the overflow transaction account and may be routed to the respective issuer for authorization of payment of the overflow amount from the overflow transaction account.

In some embodiments, the processing server 102 may be configured to generate a new authorization request for both payment transactions, which may be routed to the respective issuing institutions and authorized accordingly. In other embodiments, a new authorization request may be generated for one payment transaction, while the initial authorization request may be utilized for the other payment transaction (e.g., including modification of the transaction amount in addition to replacement of the payment credentials). Once approval of both additional payment transactions is received by the processing server 102 (e.g., as authorization responses which include a data element configured to store a response code indicating approval of the payment transaction), the processing server 102 may return an authorization response for the initial payment transaction to the payment network 112 via payment rails associated therewith indicating that the payment transaction is approved. The payment network 112 may then forward the authorization response to the merchant 108 (e.g., directly or via one or more intermediate entities), and the merchant 108 may finalize the payment transaction (e.g., by providing the consumer 104 with the transacted-for goods or services). In cases where both additional transactions are declined, the processing server 102 may return an authorization response to the payment network 112 indicating that the initial payment transaction is declined. In instances where only one additional transaction is declined, the processing server 102 may decline the initial payment transaction (e.g., and inform the issuing institution of the approved payment transaction for cancellation of the transaction) or may provide a partial authorization for the initial payment transaction that is authorized for the amount of the approved payment transaction (e.g., the voucher amount or the overflow amount, as applicable).

The methods and systems discussed herein thus enable a vendor 106 to provide multiple vouchers to a consumer 104 through a single CPN. The consumer 104 is then free to use that CPN for any transactions for redemption of the vouchers, including for transactions where the amount may go beyond the value of the voucher. In such instances, any remaining amount will be funded via the consumer's own transaction account, while the portion attributable to the voucher will be funded by an account specified by the vendor 106, all while the consumer 104 only has to provide a single CPN to a merchant 108. The result is significantly easier usage by consumers 104 where only a single CPN needs to be used for multiple vouchers and where multiple payment instruments do not need to be presented to a merchant 108. In addition, merchants 108 do not need to utilize specially configured point of sale systems, as only a single CPN is used and can be processed at the merchant 108 using standard methods, thus resulting in higher adoption and the ability for usage of the system 100 on legacy merchant systems, which is an advantage over existing gift card and voucher redemption systems. Accordingly, the methods and systems discussed herein provide a technological solution for redeeming vouchers via a CPN transaction that is a significant improvement in both technology and user interfacing than traditional systems.

### Processing Server

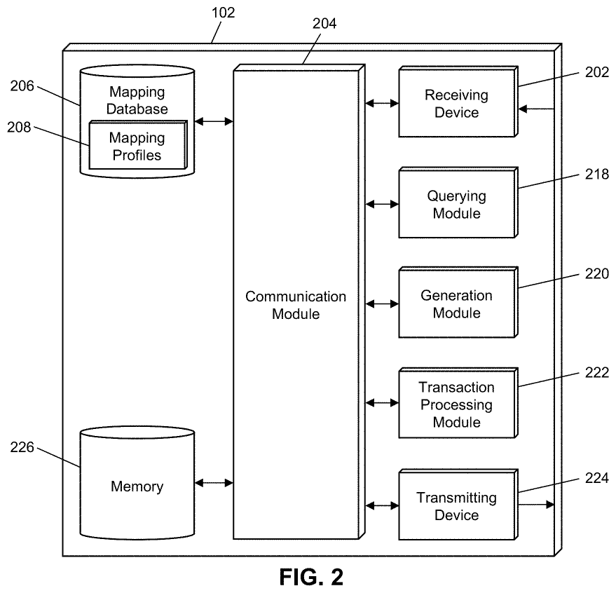

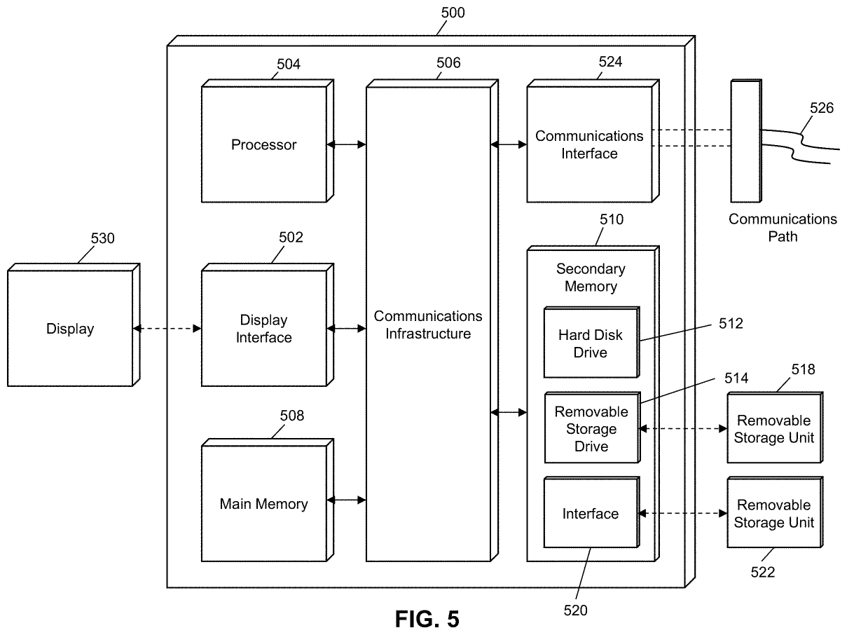

FIG. 2 illustrates an embodiment of a processing server 102 in the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 500 illustrated in FIG. 5 and discussed in more detail below may be a suitable configuration of the processing server 102.

The processing server 102 may include a receiving device 202. The receiving device 202 may be configured to receive data over one or more networks via one or more network protocols. In some instances, the receiving device 202 may be configured to receive data from vendors 106, mobile devices 110, payment networks 112, and other systems and entities via one or more communication methods, such as radio frequency, local area networks, wireless area networks, cellular communication networks, Bluetooth, the Internet, etc. In some embodiments, the receiving device 202 may be comprised of multiple devices, such as different receiving devices for receiving data over different networks, such as a first receiving device for receiving data over a local area network and a second receiving device for receiving data via the Internet. The receiving device 202 may receive electronically transmitted data signals, where data may be superimposed or otherwise encoded on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals electronically transmitted by vendors 106 that may be superimposed or otherwise encoded with voucher information, including spend controls and account information for one or more transaction accounts used to fund vouchers. The receiving device 202 may also be configured to receive data signals electronically transmitted by vendors 106 or mobile devices 110 that are superimposed or otherwise encoded with account information associated with a transaction account of the consumer 104 to be used for overflow in payment transactions for which vouchers are to be redeemed. The receiving device 202 may also be configured to receive data signals electronically transmitted by payment networks 112, issuing institutions, and other entities related to the processing of payment transactions, which may be superimposed or otherwise encoded with transaction messages and performed using payment rails associated with a payment network 112. The transaction messages may include authorization requests and authorization responses, and may include a plurality of data elements configured to store transaction data for use in performing the functions discussed herein.

The processing server 102 may also include a communication module 204. The communication module 204 may be configured to transmit data between modules, engines, databases, memories, and other components of the processing server 102 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the processing server 102 and external components of the processing server 102, such as externally connected databases, display devices, input devices, etc. The processing server 102 may also include a processing device. The processing device may be configured to perform the functions of the processing server 102 discussed herein as will be apparent to persons having skill in the relevant art. In some embodiments, the processing device may include and/or be comprised of a plurality of engines and/or modules specially configured to perform one or more functions of the processing device, such as a querying module 218, generation module 220, transaction processing module 222, etc. As used herein, the term “module” may be software or hardware particularly programmed to receive an input, perform one or more processes using the input, and provides an output. The input, output, and processes performed by various modules will be apparent to one skilled in the art based upon the present disclosure.

The processing server 102 may include a mapping database 206. The mapping database 206 may be configured to store a plurality of mapping profiles 208 using a suitable data storage format and schema. The mapping database 206 may be a relational database that utilizes structured query language for the storage, identification, modifying, updating, accessing, etc. of structured data sets stored therein. Each mapping profile 208 may be a structured data set configured to store data related to one or more vouchers. A mapping profile 208 may include at least account information for an overflow transaction account, a controlled payment number mapped thereto, and one or more spend profiles. Each spend profile may be related to a voucher and include at least account information for a transaction account used to fund the voucher and one or more spend controls, including at least a maximum transaction amount. In some cases, a mapping profile 208 may include additional spend controls applicable to the controlled payment number.

The processing server 102 may include a querying module 218. The querying module 218 may be configured to execute queries on databases to identify information. The querying module 218 may receive one or more data values or query strings, and may execute a query string based thereon on an indicated database, such as the mapping database 206, to identify information stored therein. The querying module 218 may then output the identified information to an appropriate engine or module of the processing server 102 as necessary. The querying module 218 may, for example, execute a query on the mapping database 206 to identify a mapping profile 208 that includes a controlled payment number included in a received authorization request, for identification of applicable vouchers and the overflow transaction account.

The processing server 102 may also include a generation module 220. The generation module 220 may be configured to generate data for use by the processing server 102 in performing the functions discussed herein. The generation module 220 may receive instructions as input, may generate data based on the instructions, and may output the generated data to one or more modules of the processing server 102. For example, the generation module 220 may be configured to generate notifications and other data messages for transmission to mobile devices 110, such as prompts for requesting account information, notifications of voucher balances, notifications of voucher redemption, etc. The generation module 220 may also be configured to generate transaction messages, including authorization requests, for use in processing electronic payment transactions, such as for processing additional payment transactions corresponding to a received authorization request where a voucher is to be redeemed.

The processing server 102 may also include a transaction processing module 222. The transaction processing module 222 may be configured to perform functions associated with the processing of transactions as part of the processing server 102 as discussed herein. For example, the transaction processing module 222 may be configured to initiate additional payment transactions for voucher redemptions, replace data stored in data elements included in authorization requests and responses (e.g., for mapping of transaction account information), determine transaction amounts, perform partial authorizations, decline payment transactions, etc.

The processing server 102 may also include a transmitting device 224. The transmitting device 224 may be configured to transmit data over one or more networks via one or more network protocols. In some instances, the transmitting device 224 may be configured to transmit data to vendors 106, mobile devices 110, payment networks 112, and other entities via one or more communication methods, local area networks, wireless area networks, cellular communication, Bluetooth, radio frequency, the Internet, etc. In some embodiments, the transmitting device 224 may be comprised of multiple devices, such as different transmitting devices for transmitting data over different networks, such as a first transmitting device for transmitting data over a local area network and a second transmitting device for transmitting data via the Internet. The transmitting device 224 may electronically transmit data signals that have data superimposed that may be parsed by a receiving computing device. In some instances, the transmitting device 224 may include one or more modules for superimposing, encoding, or otherwise formatting data into data signals suitable for transmission.

The transmitting device 224 may be configured to electronically transmit data signals to vendors 106 and mobile devices 110 that are superimposed or otherwise encoded with data requests, such as requests for account information for voucher transaction accounts and/or overflow transaction accounts. The transmitting device 224 may also be configured to electronically transmit data signals to vendors and/or mobile devices 110 that are superimposed or otherwise encoded with notifications regarding redemption of vouchers, such as updated on remaining voucher amounts, notifications of redeemed vouchers, data regarding applicability of a voucher (e.g., associated spend controls), etc. The transmitting device 224 may also be configured to electronically transmit data signals to mobile devices 110 (e.g., or vendors 106 for transmission thereto, as applicable) that are superimposed or otherwise encoded with a controlled payment number for use in future payment transactions. The transmitting device 224 may be further configured to electronically transmit transaction messages to payment networks 112 and other entities via payment rails associated therewith.

The processing server 102 may also include a memory 226. The memory 226 may be configured to store data for use by the processing server 102 in performing the functions discussed herein, such as public and private keys, symmetric keys, etc. The memory 226 may be configured to store data using suitable data formatting methods and schema and may be any suitable type of memory, such as read-only memory, random access memory, etc. The memory 226 may include, for example, encryption keys and algorithms, communication protocols and standards, data formatting standards and protocols, program code for modules and application programs of the processing device, and other data that may be suitable for use by the processing server 102 in the performance of the functions disclosed herein as will be apparent to persons having skill in the relevant art. In some embodiments, the memory 226 may be comprised of or may otherwise include a relational database that utilizes structured query language for the storage, identification, modifying, updating, accessing, etc. of structured data sets stored therein. The memory 226 may be configured to store, for example, CPNs for issuing, available spend controls, routing information, etc.

### Process for Registration and Usage of CPNs

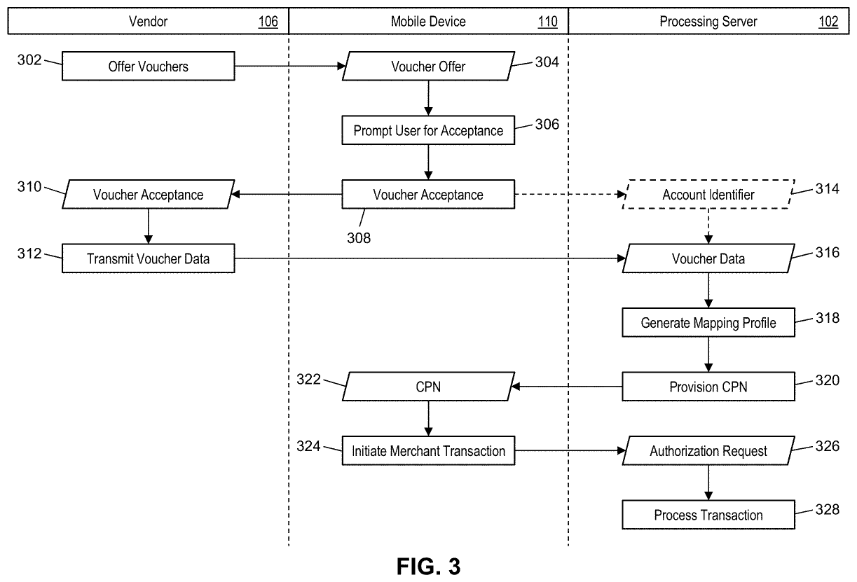

FIG. 3 illustrates an example process 300 for the registration of a new controlled payment number (CPN) associated with multiple vouchers and use thereof in a payment transaction in the system 100 of FIG. 1.

In step 302, the vendor 106 may electronically transmit a message to the mobile device 110 of the consumer 104 offering several vouchers to the consumer 104. For instance, in the above example an airline may be providing the consumer 104 with an offer for vouchers for meals, a hotel, and a future ticket purchase in exchange for taking a bump on a flight. In step 304, the mobile device 110 may receive the offer, which may be transmitted using any suitable communication network and method. In step 306, the mobile device 110 may display a prompt to the consumer 104 informing the consumer of the offer and requesting that the user accept or decline the vendor's offer. The consumer 104 may indicate their acceptance using a suitable input method of the mobile device 110. In step 308, the mobile device 110 may electronically transmit the consumer's acceptance to the vendor 106. In step 310, the vendor 106 may receive the consumer's acceptance of the voucher offer.

In step 312, the vendor 106 may electronically transmit voucher data to the processing server 102 using a suitable communication network and method. The voucher data may include at least account information applicable to each voucher being registered as well as one or more spend controls applicable to the respective voucher. In some embodiments, the voucher data may include account information for the overflow transaction account, which may have been provided to the vendor 106 by the consumer 104 via the mobile device 110 in steps 308 and 310 (e.g., where the consumer 104 selected a transaction account for use as the overflow account in responding to the prompt in step 306). In other embodiments, the mobile device 110 may electronically transmit the account information for the overflow transaction account to the processing server 102 in step 314, for receipt by the receiving device 202 thereof.

In step 316, the receiving device 202 of the processing server 102 may receive the voucher data. In step 318, the querying module 218 of the processing server 102 may execute a query on the mapping database 206 to insert a new mapping profile 208 therein. The new mapping profile 208 may include a spend profile for each of the vouchers being registered, the overflow transaction account information, and a CPN. The CPN may be generated by the generation module 220 of the processing server 102 or otherwise identified by the processing server 102. In step 320, the transmitting device 224 of the processing server 102 may electronically transmit the CPN to the mobile device 110. In step 322, the mobile device 110 may receive the CPN from the processing server 102.

In step 324, the mobile device 110 may initiate an electronic payment transaction at a merchant 108 for redemption of one of the vouchers. As part of the initiation of the payment transaction, the mobile device 110 may convey the CPN to the merchant 108. The CPN may be conveyed using any suitable method, such as by transmission via near field communication, Bluetooth, radio frequency, or other electronic transmission, via the display of a machine-readable code encoded with the CPN readable by the merchant's point of sale system, etc. The merchant 108 may receive the CPN and may submit the payment transaction to the payment network 112 for processing, where the payment network 112 may route an authorization request for the payment transaction to the processing server 102, for receipt by the receiving device 202 thereof, in step 326. In step 328, the transaction processing module 222 of the processing server 102 may process the payment transaction as discussed above. Processing of the payment transaction may be based on applicability of a voucher (e.g., determined based on the applicable spend controls and transaction data in the authorization request), total transaction amount, and compliance with the applicable spend controls. In some cases, a single payment transaction may be processed by the processing server 102, such as with the overflow transaction account's issuer or the issuer identified by the vendor 106 in the supplied account information. In other cases, the processing server 102 may process multiple payment transactions, such as for redemption of the voucher and payment of an overflow amount by the consumer's selected overflow transaction account.

Exemplary Method for Processing a Controlled Payment Number Transaction with Multiple Funding Sources

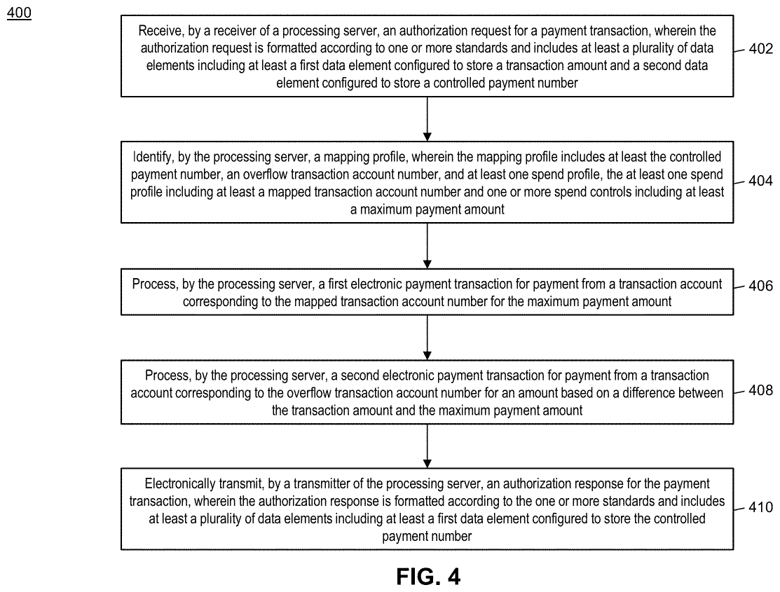

FIG. 4 illustrates a method 400 for the processing of an electronic payment transaction funded through a controlled payment number that is mapped to multiple funding sources used to fund the electronic payment transaction as split into multiple parts.

In step 402, an authorization request may be received for a payment transaction by a receiver (e.g., the receiving device 202) of a processing server (e.g., the processing server 102), wherein the authorization request is formatted according to one or more standards and includes at least a plurality of data elements including at least a first data element configured to store a transaction amount and a second data element configured to store a controlled payment number. In step 404, a mapping profile (e.g., mapping profile 208) may be identified by the processing server, wherein the mapping profile includes at least the controlled payment number, an overflow transaction account number, and at least one spend profile, the at least one spend profile including at least a mapped transaction account number and one or more spend controls including at least a maximum payment amount.

In step 406, a first electronic payment transaction may be processed by the processing server for payment from a transaction account corresponding to the mapped transaction account number for the maximum payment amount. In step 408, a second electronic payment transaction may be processed by the processing server for payment from a transaction account corresponding to the overflow transaction account number for an amount based on a difference between the transaction amount and the maximum payment amount. In step 410, an authorization response may be electronically transmitted by a transmitter (e.g., the transmitting device 224) of the processing server for the payment transaction, wherein the authorization response is formatted according to the one or more standards and includes at least a plurality of data elements including at least a first data element configured to store the controlled payment number.

In one embodiment, the at least one spend profile may further include a merchant category code, and the plurality of data elements included in the authorization request may further include a third data element configured to store the merchant category code. In a further embodiment, the mapping profile may further include at least one additional spend profile, each additional spend profile including a separate merchant category code and a separate transaction account number. In some embodiments, processing the second electronic payment transaction may include modifying, by the processing server, the authorization request to replace the controlled payment number with the overflow transaction account number and to replace the transaction amount with the difference between the transaction amount and the maximum payment amount.

In one embodiment, processing the first electronic payment transaction may include: generating, by the processing server, a second authorization request, wherein the second authorization request is formatted according to the one or more standards and includes a plurality of data elements including at least a first data element configured to store the maximum payment amount and a second data element configured to store the mapped transaction account number; and electronically transmitting, by the transmitter of the processing server, the generated second authorization request to a financial institution that issued the transaction account corresponding to the mapped transaction account number. In some embodiments, processing the second electronic payment transaction may include: generating, by the processing server, a second authorization request, wherein the second authorization request is formatted according to the one or more standards and includes a plurality of data elements including at least a first data element configured to store the difference between the transaction amount and the maximum payment amount and a second data element configured to store the overflow transaction account number; and electronically transmitting, by the transmitter of the processing server, the generated second authorization request to a financial institution that issued the transaction account corresponding to the overflow transaction account number.

In one embodiment, the method 400 may further include: electronically transmitting, by the transmitter of the processing server, a request message to a mobile communication device, wherein the request message includes at least one of: the transaction amount and the difference between the transaction amount and the maximum payment amount; and receiving, by the receiver of the processing server, a notification from the mobile communication device indicating approval to process the first electronic payment transaction and the second electronic payment transaction prior to processing of the first electronic payment transaction or second electronic payment transaction. In some embodiments, the one or more spend controls may further include at least an expiration date and a geographic area, the plurality of data elements included in the authorization request may further include a third data element configured to store a transaction date and a fourth data element configured to store a geographic location, the transaction date may be less than or equal to the expiration date, and the geographic location may be located within the geographic area.

### Computer System Architecture

FIG. 5 illustrates a computer system 500 in which embodiments of the present disclosure, or portions thereof, may be implemented as computer-readable code. For example, the processing server 102 of FIG. 1 may be implemented in the computer system 500 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3 and 4.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 518, a removable storage unit 522, and a hard disk installed in hard disk drive 512.

Various embodiments of the present disclosure are described in terms of this example computer system 500. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 504 may be a special purpose or a general purpose processor device specifically configured to perform the functions discussed herein. The processor device 504 may be connected to a communications infrastructure 506, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 500 may also include a main memory 508 (e.g., random access memory, read-only memory, etc.), and may also include a secondary memory 510. The secondary memory 510 may include the hard disk drive 512 and a removable storage drive 514, such as a floppy disk drive, a magnetic tape drive, an optical disk drive, a flash memory, etc.

The removable storage drive 514 may read from and/or write to the removable storage unit 518 in a well-known manner. The removable storage unit 518 may include a removable storage media that may be read by and written to by the removable storage drive 514. For example, if the removable storage drive 514 is a floppy disk drive or universal serial bus port, the removable storage unit 518 may be a floppy disk or portable flash drive, respectively. In one embodiment, the removable storage unit 518 may be non-transitory computer readable recording media.

In some embodiments, the secondary memory 510 may include alternative means for allowing computer programs or other instructions to be loaded into the computer system 500, for example, the removable storage unit 522 and an interface 520. Examples of such means may include a program cartridge and cartridge interface (e.g., as found in video game systems), a removable memory chip (e.g., EEPROM, PROM, etc.) and associated socket, and other removable storage units 522 and interfaces 520 as will be apparent to persons having skill in the relevant art.

Data stored in the computer system 500 (e.g., in the main memory 508 and/or the secondary memory 510) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 500 may also include a communications interface 524. The communications interface 524 may be configured to allow software and data to be transferred between the computer system 500 and external devices. Exemplary communications interfaces 524 may include a modem, a network interface (e.g., an Ethernet card), a communications port, a PCMCIA slot and card, etc. Software and data transferred via the communications interface 524 may be in the form of signals, which may be electronic, electromagnetic, optical, or other signals as will be apparent to persons having skill in the relevant art. The signals may travel via a communications path 526, which may be configured to carry the signals and may be implemented using wire, cable, fiber optics, a phone line, a cellular phone link, a radio frequency link, etc.

The computer system 500 may further include a display interface 502. The display interface 502 may be configured to allow data to be transferred between the computer system 500 and external display 530. Exemplary display interfaces 502 may include high-definition multimedia interface (HDMI), digital visual interface (DVI), video graphics array (VGA), etc. The display 530 may be any suitable type of display for displaying data transmitted via the display interface 502 of the computer system 500, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 508 and secondary memory 510, which may be memory semiconductors (e.g., DRAMs, etc.). These computer program products may be means for providing software to the computer system 500. Computer programs (e.g., computer control logic) may be stored in the main memory 508 and/or the secondary memory 510. Computer programs may also be received via the communications interface 524. Such computer programs, when executed, may enable computer system 500 to implement the present methods as discussed herein. In particular, the computer programs, when executed, may enable processor device 504 to implement the methods illustrated by FIGS. 3 and 4, as discussed herein. Accordingly, such computer programs may represent controllers of the computer system 500. Where the present disclosure is implemented using software, the software may be stored in a computer program product and loaded into the computer system 500 using the removable storage drive 514, interface 520, and hard disk drive 512, or communications interface 524.

The processor device 504 may comprise one or more modules or engines configured to perform the functions of the computer system 500. Each of the modules or engines may be implemented using hardware and, in some instances, may also utilize software, such as corresponding to program code and/or programs stored in the main memory 508 or secondary memory 510. In such instances, program code may be compiled by the processor device 504 (e.g., by a compiling module or engine) prior to execution by the hardware of the computer system 500. For example, the program code may be source code written in a programming language that is translated into a lower level language, such as assembly language or machine code, for execution by the processor device 504 and/or any additional hardware components of the computer system 500. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 500 to perform the functions disclosed herein. It will be apparent to persons having skill in the relevant art that such processes result in the computer system 500 being a specially configured computer system 500 uniquely programmed to perform the functions discussed above.

Techniques consistent with the present disclosure provide, among other features, systems and methods for processing a controlled payment number transaction with multiple funding sources. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for processing a controlled payment number transaction with multiple funding sources, comprising:
receiving, by a receiver of a processing server, an authorization request for a payment transaction, wherein the authorization request is formatted according to one or more standards and includes at least a plurality of data elements including at least a first data element configured to store a transaction amount and a second data element configured to store a controlled payment number;
identifying, by the processing server, a mapping profile, wherein the mapping profile includes at least the controlled payment number, an overflow transaction account number, and at least one spend profile, the at least one spend profile including at least a mapped transaction account number and one or more spend controls including at least a maximum payment amount;
processing, by the processing server, a first electronic payment transaction for payment from a transaction account corresponding to the mapped transaction account number for the maximum payment amount;
processing, by the processing server, a second electronic payment transaction for payment from a transaction account corresponding to the overflow transaction account number for an amount based on a difference between the transaction amount and the maximum payment amount; and
electronically transmitting, by a transmitter of the processing server, an authorization response for the payment transaction, wherein the authorization response is formatted according to the one or more standards and includes at least a plurality of data elements including at least a first data element configured to store the controlled payment number.

2. The method of claim 1, wherein
the at least one spend profile further includes a merchant category code, and
the plurality of data elements included in the authorization request further includes a third data element configured to store the merchant category code.

3. The method of claim 2, wherein the mapping profile further includes at least one additional spend profile, each additional spend profile including a separate merchant category code and a separate transaction account number.

4. The method of claim 1, wherein processing the first electronic payment transaction includes:
generating, by the processing server, a second authorization request, wherein the second authorization request is formatted according to the one or more standards and includes a plurality of data elements including at least a first data element configured to store the maximum payment amount and a second data element configured to store the mapped transaction account number; and
electronically transmitting, by the transmitter of the processing server, the generated second authorization request to a financial institution that issued the transaction account corresponding to the mapped transaction account number.

5. The method of claim 1, wherein processing the second electronic payment transaction includes:
generating, by the processing server, a second authorization request, wherein the second authorization request is formatted according to the one or more standards and includes a plurality of data elements including at least a first data element configured to store the difference between the transaction amount and the maximum payment amount and a second data element configured to store the overflow transaction account number; and
electronically transmitting, by the transmitter of the processing server, the generated second authorization request to a financial institution that issued the transaction account corresponding to the overflow transaction account number.

6. The method of claim 1, wherein processing the second electronic payment transaction includes modifying, by the processing server, the authorization request to replace the controlled payment number with the overflow transaction account number and to replace the transaction amount with the difference between the transaction amount and the maximum payment amount.

7. The method of claim 1, further comprising:
electronically transmitting, by the transmitter of the processing server, a request message to a mobile communication device, wherein the request message includes at least one of: the transaction amount and the difference between the transaction amount and the maximum payment amount; and
receiving, by the receiver of the processing server, a notification from the mobile communication device indicating approval to process the first electronic payment transaction and the second electronic payment transaction prior to processing of the first electronic payment transaction or second electronic payment transaction.

8. The method of claim 1, wherein
the one or more spend controls further includes at least an expiration date and a geographic area,
the plurality of data elements included in the authorization request further includes a third data element configured to store a transaction date and a fourth data element configured to store a geographic location,
the transaction date is less than or equal to the expiration date, and
the geographic location is located within the geographic area.

9. A system for processing a controlled payment number transaction with multiple funding sources, comprising:
a receiver of a processing server configured to receive an authorization request for a payment transaction, wherein the authorization request is formatted according to one or more standards and includes at least a plurality of data elements including at least a first data element configured to store a transaction amount and a second data element configured to store a controlled payment number;
the processing server configured to
identify a mapping profile, wherein the mapping profile includes at least the controlled payment number, an overflow transaction account number, and at least one spend profile, the at least one spend profile including at least a mapped transaction account number and one or more spend controls including at least a maximum payment amount,
process a first electronic payment transaction for payment from a transaction account corresponding to the mapped transaction account number for the maximum payment amount,
process a second electronic payment transaction for payment from a transaction account corresponding to the overflow transaction account number for an amount based on a difference between the transaction amount and the maximum payment amount; and
a transmitter of the processing server configured to electronically transmit an authorization response for the payment transaction, wherein the authorization response is formatted according to the one or more standards and includes at least a plurality of data elements including at least a first data element configured to store the controlled payment number.

10. The system of claim 9, wherein
the at least one spend profile further includes a merchant category code, and
the plurality of data elements included in the authorization request further includes a third data element configured to store the merchant category code.

11. The system of claim 10, wherein the mapping profile further includes at least one additional spend profile, each additional spend profile including a separate merchant category code and a separate transaction account number.

12. The system of claim 9, wherein processing the first electronic payment transaction includes:
generating, by the processing server, a second authorization request, wherein the second authorization request is formatted according to the one or more standards and includes a plurality of data elements including at least a first data element configured to store the maximum payment amount and a second data element configured to store the mapped transaction account number; and
electronically transmitting, by the transmitter of the processing server, the generated second authorization request to a financial institution that issued the transaction account corresponding to the mapped transaction account number.

13. The system of claim 9, wherein processing the second electronic payment transaction includes:
generating, by the processing server, a second authorization request, wherein the second authorization request is formatted according to the one or more standards and includes a plurality of data elements including at least a first data element configured to store the difference between the transaction amount and the maximum payment amount and a second data element configured to store the overflow transaction account number; and
electronically transmitting, by the transmitter of the processing server, the generated second authorization request to a financial institution that issued the transaction account corresponding to the overflow transaction account number.

14. The system of claim 9, wherein processing the second electronic payment transaction includes modifying, by the processing server, the authorization request to replace the controlled payment number with the overflow transaction account number and to replace the transaction amount with the difference between the transaction amount and the maximum payment amount.

15. The system of claim 9, wherein
the transmitter of the processing server is further configured to electronically transmit a request message to a mobile communication device, wherein the request message includes at least one of: the transaction amount and the difference between the transaction amount and the maximum payment amount, and
the receiver of the processing server is further configured to receive a notification from the mobile communication device indicating approval to process the first electronic payment transaction and the second electronic payment transaction prior to processing of the first electronic payment transaction or second electronic payment transaction.

16. The system of claim 9, wherein
the one or more spend controls further includes at least an expiration date and a geographic area,
the plurality of data elements included in the authorization request further includes a third data element configured to store a transaction date and a fourth data element configured to store a geographic location,
the transaction date is less than or equal to the expiration date, and the geographic location is located within the geographic area.
